(19) United States
(12) Patent Application Publication
(10) Pub. No.: US 2012/0043689 A1
(43) Pub. Date: Feb. 23, 2012

(54) METHOD FOR MANUFACTURING COMPOSITE OF METAL AND RESIN

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); HUA-YANG XU, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/978,615

(22) Filed: Dec. 26, 2010

(30) Foreign Application Priority Data
Aug. 19, 2010 (CN) 201010257306.7

(51) Int. Cl. B29C 45/14

(52) U.S. Cl. 264/154

(57) ABSTRACT

A method for manufacturing a composite of metal and resin includes steps of: providing a metal piece; cleaning the metal piece in a degreasing agent solution; partially shielding the metal piece and remaining portions of the metal surface uncovered; blasting the metal piece with hard particles to form a plurality of micro pores in the uncovered portion; inserting the metal piece into a mold; injecting molten resin material on the metal piece, the resin material combined with the metal piece when the resin material is cool.

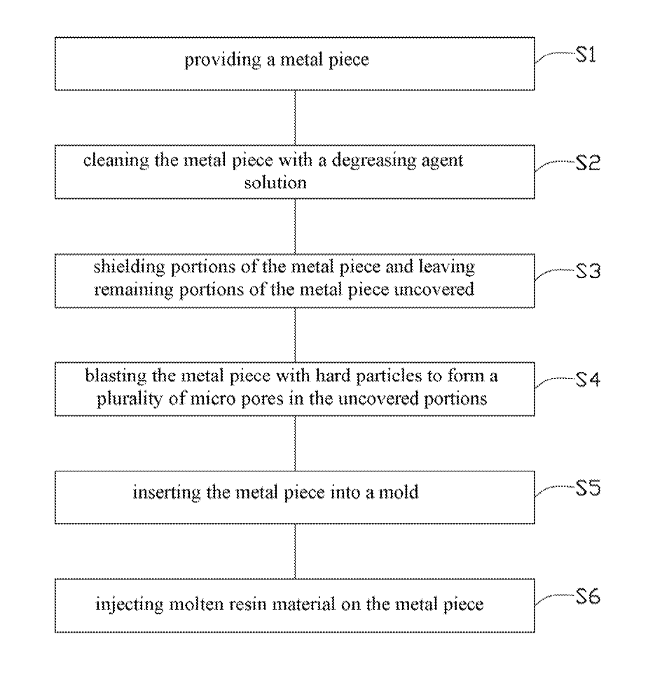

### CROSS-REFERENCE TO RELATED APPLICATIONS

This application is related to co-pending U.S. Patent Applications (Attorney Docket Nos. US34448 and US34449), entitled “METHOD FOR MANUFACTURING COMPOSITE OF METAL AND RESIN” and “COMPOSITE OF METAL AND RESIN AND MANUFACTURING METHOD THEREOF”. Such applications have the same assignee as the present application. The above-identified applications are incorporated herein by reference.

### BACKGROUND

### Technical Field

This disclosure relates to how to manufacture composite of metal and resin.

Integrated metals and synthetic resins are used in a wide range of industrial fields including the production of parts for automobiles, domestic appliances, industrial machinery, and the like. Generally, the metal and the resin are joined together by adhesive. However, this method cannot supply a high-strength composite of metal and resin.

A method of injection joining for manufacturing composites of metal and resin appears to overcome the above shortcoming. In this method, molten resin material is injected onto a metal part that has been inserted in advance into an injection molding mold. The metal part has a surface combined with the resin. Generally, before inserting the metal part in the mold, a surface of the metal is treated by an etchant so that a stronger bond is formed with the resin material. However, different etchants must be used for different metals. In addition, the etchants are strong acids or alkalis, which require special handling when disposing the etchants after use to protect the environment.

Therefore, there is room for improvement within the art.

### BRIEF DESCRIPTION OF THE DRAWINGS

Many aspects of method for manufacturing composite of metal and resin can be better understood with reference to the following drawing.

The figure is a block diagram of an exemplary process for manufacturing a composite of metal and resin.

### DETAILED DESCRIPTION

The figure shows an exemplary method for manufacturing a composite of metal and resin, which includes following steps.

Step S1, a metal piece is provided. The metal piece can be formed by any process, such as machining or casting. The material of the metal piece can be selected from the group consisting of aluminum alloy, magnesium alloy, stainless steel alloy, copper, and copper alloy.

Step S2, the metal piece is cleaned with a degreasing agent solution. The metal piece is immersed in the solution having a temperature in an approximate range of 20° C. to 30° C. for 1 minute to 6 minutes. The concentration of degreasing agent contained in the solution is in the approximate range of 90 grams/liter (g/l) to 150 grams/liter (g/l). The metal piece is washed with water after removal from the solution.

Step S3, the metal piece is partially shielded and remaining portions of the metal surface remain uncovered. Portions of the metal surface which need to be combined with resin can be shielded by, for example, masking using binding tape or photosensitive resist.

Step S4, the metal piece is blasted with hard particles to form a plurality of micro pores in the uncovered portions. An average diameter of the micro pores is less than 0.3 μm, and in the exemplary embodiment is in a range of 0.05 μm to 0.25 μm. An average depth of the micro pores is in a range of 0.06 μm to 0.12 μm. A blasting pressure is in a range of 6 bars to 10 bars. An average diameter of hard particles is in a range of 1.3 μm to 2.6 μm. The hard particles can be selected from the group consisting of natural diamond, synthetic diamond, silicon oxide, and silicon carbide.

Step S5, the metal piece is inserted into a mold. The metal piece is heated to a temperature in a range of 100° C. to 350° C. The heating can be accomplished using electromagnetic induction.

Step S6, molten resin material is injected into the mold and onto the metal piece. The resin material is thermoplastic resin and crystallizes when it cools. The molten resin material becomes partially embedded in the micro pores and bonds with the metal piece when the resin material is cool. The crystallized-type thermoplastic resin material can be selected from the group consisting of a composite of polyphentlene sulfide and glass fiber, polyamide, polyethylene terephthalate, or polybutylene terephthalate. When using the polyphentlene sulfide and glass fiber composite, the percentage composition of the glass fiber is in a range of 20% to 50%.

Tensile and shear strength tests are applied to the composite of metal and resin made by the above method. The results show that the tensile strength of the composite can reach 10 MPa, and the shear strength of the composite can reach 25 MPa. After repeated cold and hot shock testing for 48 hours at temperatures in a range of −40° C. to 85° C., in 4 hour cycles, the tensile and shear strength of the composite of metal and resin does not become notably weaker.

It is to be understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for manufacturing a composite of metal and resin, comprising:
providing a metal piece;
cleaning the metal piece with a degreasing agent solution;
shielding portions of the metal piece and leaving remaining portions of the metal piece uncovered;
blasting the metal piece with hard particles to form a plurality of micro pores in the uncovered portions;
inserting the metal piece into a mold;
injecting molten resin material on the metal piece, the resin material combining with the metal piece as the resin material cools.

2. The method as claimed in claim 1, wherein an average diameter of the micro pores is less than 0.3 μm.

3. The method as claimed in claim 2, wherein an average diameter of the micro pores is in a range of 0.05 μm to 0.25 μm, and an average depth of the micro pores is in a range of 0.06 μm to 0.12 μm.

4. The method as claimed in claim 1, wherein the injection pressure of the particles is in a range of 6 bars to 10 bars, and an average diameter of hard particles is in a range of 1.3 μm to 2.6 μm.

5. The method as claimed in claim 1, wherein the hard particles is selected from the group consisting of natural diamond, synthetic diamond, silicon oxide and silicon carbide.

6. The method as claimed in claim 1, wherein the metal piece is immersed in the solution with degreasing agent for 1 minute to 6 minutes, the solution has a temperature in an approximate range of 20° C. to 30° C., and the concentration of degreasing agent contained in the solution is in a range of 90 grams/liter to 150 grams/liter.

7. The method as claimed in claim 1, wherein the metal piece is shield by mask, binding tape, or photosensitive resist.

8. The method as claimed in claim 1, wherein material of the metal piece is selected from the group consisting of aluminum alloy, magnesium alloy, stainless steel alloy, copper and copper alloy.

9. The method as claimed in claim 1, wherein the resin material is selected from the group consisting of composite of polyphentlene sulfide and glass fiber, polyamide, polyethylene terephthalate or polybutylene terephthalate.

10. The method as claimed in claim 9, wherein in the composite of polyphentlene sulfide and glass fiber, the percentage composition of the glass fiber is in a range of 20% to 50%.
